(19) United States
(12) Patent Application Publication
(10) Pub. No.: US 2017/0045014 A1
(43) Pub. Date: Feb. 16, 2017

(54) MULTI-PIECE CYLINDER

(71) Applicants: Phil McDowell, Hillsdale, MI (US); Wendell Penrod, Hillsdale, MI (US)

(72) Inventors: Phil McDowell, Hillsdale, MI (US); Wendell Penrod, Hillsdale, MI (US)

(73) Assignee: COBRA AERO LLC, Cleveland, OH (US)

(21) Appl. No.: 15/237,122

(22) Filed: Aug. 15, 2016

Related U.S. Application Data
(63) Continuation of application No. PCT/US15/15834, filed on Feb. 13, 2015.
(60) Provisional application No. 61/939,727, filed on Feb. 13, 2014.

(51) Int. Cl. F02F 1/22; F02B 75/02

(52) U.S. Cl. CPC F02F 1/22; F02B 75/02; F02F 2200/00; F02B 2075/025

(57) ABSTRACT

A cylinder is configured for use with a piston that moves through compression and combustion strokes between top and bottom positions in an internal combustion engine. The cylinder defines a bore in which the piston moves between the top and bottom positions. The bore has a transfer port and an exhaust port. The cylinder can have interconnected parts that together define the bore. Those parts can include a first part that reaches along the bore upward from the transfer port beside the top position of the piston, and a second part that reaches along the bore downward from the transfer port beside the bottom position of the piston. The sectional lengths of the first and second parts provide greater access for manufacturing at the bore, the transfer port, and the exhaust port.

### RELATED APPLICATIONS

This application claims the priority benefit of provisional U.S. patent application 61/939,727, filed Feb. 13, 2014, which is incorporated by reference.

### TECHNICAL FIELD

This technology includes cylinders for pistons in two-cycle internal combustion engines.

### BACKGROUND

A two-cycle internal combustion engine has piston in a cylinder. The cylinder provides a combustion chamber above the piston, and has ports including a transfer port and an exhaust port. In operation, the piston reciprocates through compression and combustion strokes. As the piston moves between top and bottom positions in the cylinder, it opens and closes the transfer and exhaust ports for a fuel-air mixture to flow into the combustion chamber and for exhaust to flow out of the combustion chamber.

### SUMMARY

An apparatus is configured for use with a piston that moves through compression and combustion strokes between top and bottom positions in an internal combustion engine. The apparatus comprises a cylinder defining a bore in which the piston moves between the top and bottom positions. The bore has a transfer port and an exhaust port. The cylinder can have interconnected parts that together define the bore. Those parts can include a first part that reaches along the bore upward from the transfer port beside the top position of the piston, and a second part that reaches along the bore downward from the transfer port beside the bottom position of the piston.

Summarized differently, the cylinder can have a plurality of interconnected parts, each of which defines at least a portion of the transfer port or the exhaust port, including a first part that reaches along the bore upward from the transfer port beside the top position of the piston, and further including a second part that is received within the first part and reaches along the bore downward from the transfer port beside the bottom position of the piston.

### BRIEF DESCRIPTION OF THE DRAWINGS

FIG. 1 is a perspective view of a two-cycle internal combustion engine.

FIG. 2 is a sectional view of the engine of FIG. 1.

FIG. 3 is a view similar to FIG. 2, showing parts in different positions.

FIG. 4 is a sectional view of a part shown in FIGS. 1-3.

FIG. 5 is sectional view of the part shown in FIG. 4, taken in an opposite direction.

FIG. 6 is a separate view of another part shown in FIGS. 2 and 3.

### DETAILED DESCRIPTION

The apparatus shown in the drawings has parts that are examples of the elements recited in the claims. The illustrated apparatus thus includes examples of how a person of ordinary skill in the art can make and use the claimed invention. These examples are described here to provide enablement and best mode without imposing limitations that are not recited in the claims

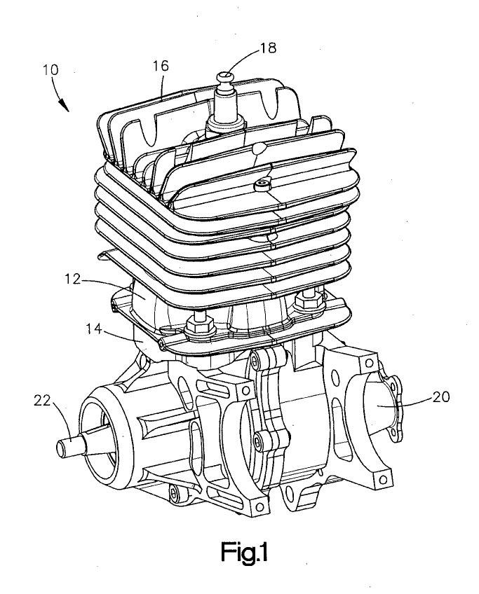

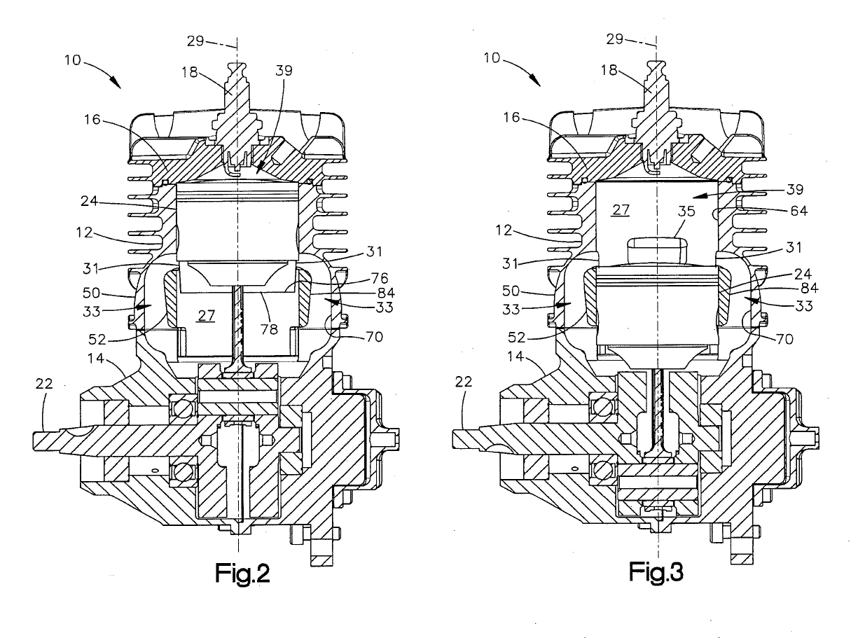

As shown in FIG. 1, a two-cycle internal combustion engine 10 includes a cylinder 12 mounted on a crankcase 14. The cylinder 12 has multiple interconnected parts, including a cylinder head 16 that supports a spark plug 18. The crankcase 14 has an intake section 20 that contains a reed valve (not shown) for admitting a combustible mixture of reactants including fuel, air and oil. A crankshaft 22 projects from the opposite end of the crankcase 14, and supports a piston 24 (FIG. 2) for movement in the cylinder 12.

As shown in FIGS. 2 and 3, the cylinder 12 has a cylindrical bore 27 centered on an axis 29. The bore 27 has a three transfer ports 31, two of which are shown in the sectional views of FIGS. 2 and 3. The transfer ports 31 are centered at locations spaced apart from each other 90 degrees about the axis 29. Three corresponding transfer ducts 33 reach upward through the cylinder 12 from the crankcase 14 to the transfer ports 31. An exhaust port 35 is located in the bore 27 above the transfer ports 31, and communicates the bore 27 with an exhaust duct that reaches to the exterior of the cylinder 12.

The piston 24 is received within the bore 27 to provide a variable volume combustion chamber 39 at the upper end of the bore 27, and is linked with the crankshaft 22 to move along the axis 29 with rotation of the crankshaft 22. The piston 24 is thus supported in the bore 27 to reciprocate through combustion and compression strokes reaching between the top and bottom positions shown in FIGS. 2 and 3. As the piston 24 moves along the length of the bore 27 in this manner, it moves over and past the transfer and exhaust ports 31 and 35 to open and close the ports 31 and 35 as needed for the combustion and exhaust strokes of the piston 24 to drive rotation of the crankshaft 22.

The interconnected parts of the cylinder 12 further include an upper part 50 and a lower part 52. The lower part 52 is received within the upper part 50, and the two parts 50 and 52 together define the bore 27.

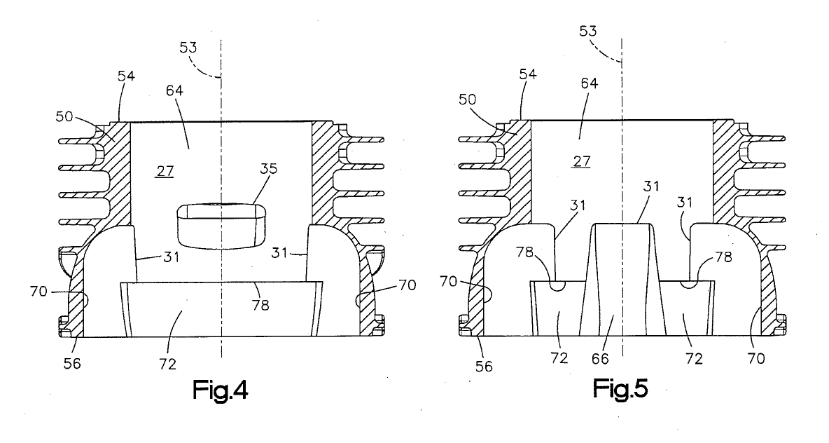

As shown separately in FIGS. 4 and 5, the upper part 50 has a generally cylindrical shape centered on an axis 53, with upper and lower end surfaces 54 and 56. In the assembled engine 10 of FIGS. 1-3, the cylinder head 16 rest on the upper end surface 54 of the upper part 50. The lower end surface 56 of the upper part 50 rests on the crankcase 14.

A cylindrical bore surface 64 of the upper part 50 reaches partially along the length of the bore 27. The bore surface 64 also reaches fully around the exhaust port 35 to define the exhaust port 35 entirely at that surface 64, as best shown in FIG. 4. The transfer ports 31 are formed partially at the bore surface 64 of the upper part 50, and partially at a bore surface 66 of the lower part 52, as described below.

Several other surfaces of the upper part 50 are recessed radially outward from the bore surface 64. These include three duct surfaces 70 that reach downward from the transfer ports 31 at locations that are likewise spaced 90 degrees circumferentially apart from each other. Three other recessed surfaces 72 of the upper part 50 reach circumferentially between the duct surfaces 70.

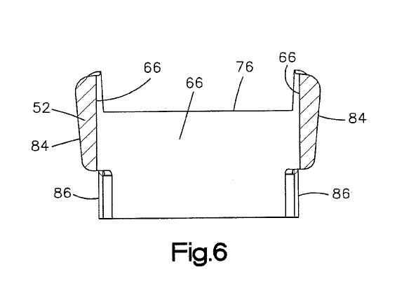

When the lower part 52 is installed in the upper part 50, the two parts 50 and 52 abut end-to-end. The end-to-end abutment of the two parts 50 and 52 is interrupted at the transfer ports 31. Specifically, upper edge surfaces 76 of the lower part 52, one of which is shown in FIG. 6, abut lower edge surfaces 78 of the upper part 50 circumferentially between the transfer ports 31. The bore surface 64 of the upper part 50 reaches partially around each transfer port 31, and the bore surface 66 of the lower part 52 reaches partially around each transfer port 31, such that the bore surfaces 64 and 66 of the two parts 50 and 52 together reach entirely around each transfer port 31. The bore surfaces 64 and 66 thus define the transfer ports 31 between the adjacent ends of the two parts 50 and 52 of the cylinder 12. The bore surface 64 of the upper part 50 then provides a section of the bore 27 that reaches upward from the transfer ports 31 beside the top position of the piston 24. The bore surface 66 of the lower part 52 provides a section of the bore 27 that reaches downward from transfer ports 31 beside the bottom position of the piston 24.

In addition to defining the bore 27 and the transfer ports 31, the upper and lower parts 50 and 52 of the cylinder 10 also define the transfer ducts 33 that communicate the crankcase 14 with the transfer ports 31. As further shown in FIGS. 2 and 3, the recessed duct surfaces 70 of the upper part 50 are spaced radially from opposed peripheral surfaces 84 of the lower part 52. The transfer ducts 33 reach upward from the crankcase 14 to the transfer ports 31 between those surfaces 70 and 84. The other recessed surfaces 72 (FIGS. 4-5) of the upper part 50 then adjoin opposed peripheral surfaces 86 (FIG. 6) of the lower part 52 in a press fit to secure the lower part 52 in its installed position.

Advantageously, each of the upper and lower parts 50 and 52 of the cylinder 10 reaches only partially along the length of the bore 27. Compared with a unitary part reaching the full length of a bore, these sectional length parts 50 and 52 provide greater access for machining or other manufacturing processes at the bore 27, the transfer ports 31, the exhaust port 35 and the ducts 33 before installing the lower part 52 within the upper part 50.

This written description sets for the best mode of carrying out the invention, and describes the invention so as to enable a person skilled in the art to make and use the invention, by presenting examples of the elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they have equivalent elements with insubstantial differences from the literal language of the claims.

What is claimed is:

1. An apparatus for use with a piston that moves through compression and combustion strokes between top and bottom positions in an internal combustion engine, the apparatus comprising:
a cylinder defining a bore in which the piston moves between the top and bottom positions, the bore having a transfer port and an exhaust port;
wherein the cylinder has interconnected parts that together define the bore, including a first part that reaches along the bore upward from the transfer port beside the top position of the piston, and a second part that reaches along the bore downward from the transfer port beside the bottom position of the piston.

2. An apparatus as defined in claim 1 wherein the second part of the cylinder is received within the first part.

3. An apparatus as defined in claim 1 wherein the second part of the cylinder is interconnected with the first part in a press fit.

4. An apparatus as defined in claim 1 wherein the first part of the cylinder defines the entire exhaust port.

5. An apparatus as defined in claim 1 wherein the first and second parts of the cylinder together define the entire transfer port.

6. An apparatus as defined in claim 5 wherein the first and second parts of the cylinder together define a duct reaching to the transfer port.

7. An apparatus comprising:
a cylinder defining a bore with a transfer port and an exhaust port; and
a piston supported in the bore for reciprocating movement between top and bottom positions to open and close the transfer port and the exhaust port in compression and combustion stokes of the piston;
wherein the cylinder has interconnected parts that together define the bore, including a first part that reaches along the bore upward from the transfer port beside the top position of the piston, and a second part that reaches along the bore downward from the transfer port beside the bottom position of the piston.

8. An apparatus as defined in claim 7 wherein the second part of the cylinder is received within the first part.

9. An apparatus as defined in claim 7 wherein the second part of the cylinder is interconnected with the first part in a press fit.

10. An apparatus as defined in claim 7 wherein the first part of the cylinder defines the entire exhaust port.

11. An apparatus as defined in claim 7 wherein the first and second parts of the cylinder together define the entire transfer port.

12. An apparatus as defined in claim 11 wherein the first and second parts of the cylinder together define a duct reaching to the transfer port.

13. An apparatus comprising:
a cylinder defining a bore with a transfer port and an exhaust port; and
a piston supported in the bore for reciprocating movement between top and bottom positions to open and close the transfer port and the exhaust port in compression and combustion stokes of the piston;
wherein the cylinder has a plurality of interconnected parts, each of which defines at least a portion of the transfer port or the exhaust port, including a first part that reaches along the bore upward from the transfer port beside the top position of the piston, and further including a second part that is received within the first part and reaches along the bore downward from the transfer port beside the bottom position of the piston.

14. An apparatus as defined in claim 13 wherein the second part of the cylinder is interconnected with the first part in a press fit.

15. An apparatus as defined in claim 13 wherein the first part of the cylinder defines the entire exhaust port.

16. An apparatus as defined in claim 13 wherein the first and second parts of the cylinder together define the entire transfer port.

17. An apparatus as defined in claim 13 wherein the first and second parts of the cylinder together define a duct reaching to the transfer port.
